(19) United States
(12) Patent Application Publication
(10) Pub. No.: US 2021/0363373 A1
(43) Pub. Date: Nov. 25, 2021

(54) FABRIC COATING COMPOSITION

(71) Applicant: Hewlett-Packard Development Company, L.P., Spring, TX (US)

(72) Inventors: Xiaoqi Zhou, San Diego, CA (US); Zhang-Lin Zhou, San Diego, CA (US)

(73) Assignee: Hewlett-Packard Development Company, L.P., Spring, TX (US)

(21) Appl. No.: 17/059,752

(22) PCT Filed: Jan. 11, 2019
(86) PCT No.: PCT/US2019/013265

§ 371 Date: Nov. 30, 2020

(51) Int. Cl. C09D 11/54; C09D 11/033; C09D 11/102; C09D 11/38; D06P 5/30; D06P 5/00; D06P 1/52; D06P 1/54; D06P 1/44; D06P 1/673; B41M 1/26; B41J 3/407

(52) U.S. Cl. CPC C09D 11/54; C09D 11/033; C09D 11/102; C09D 11/38; D06P 5/30; D06P 5/002; B41J 3/4078; D06P 1/5278; D06P 1/54; D06P 1/445; D06P 1/6735; B41M 1/26; D06P 1/5285

(57) ABSTRACT

A fabric coating composition, comprising from 2 to 50 dry parts of a crosslinking polymer, from 5 to 60 dry parts of a polymeric binder; from 2 to 30 dry parts of pigment fixation agents, parts are based on total dry content of the coating composition; a pH control agent in an amount adjusted to have a pH above 7; and an aqueous liquid vehicle is described. The coating composition is used to be applied to a fabric print medium. Also described herein are a coated fabric printable medium, a method for forming the coated fabric printable medium and a method of textile printing that includes ejecting an ink composition onto the coated fabric print medium described herein.

### BACKGROUND

Textile is a flexible material consisting of a network of natural or artificial fibers which form yarn or thread. Textiles have an assortment of uses in the daily life, such as clothing, bags, baskets, upholstered furnishings, window shades, towels, coverings for tables, beds, and other flat surfaces, and in art. Textiles are used in many traditional crafts such as sewing, quilting and embroidery. The coloration of the textile includes often the dyeing and printing. The dyeing is to apply colorant to the whole fabric network including yarn and thread. The printing is to place the specific design pattern in a special area under the design. Screen printing is a traditional method for fabric textile printing over decades. With the rapid development of digital printing technology, the inkjet printing is increasing its application range and volume in textile printing. The inkjet printing method, such as thermal inkjet and piezoelectric inkjet, dye sublimation inkjet and the alike have been under the investigation and some of these technologies have successfully been commercialized in the printing industry.

### DETAILED DESCRIPTION

When printing on fabric substrates, challenges exist due to the specific nature of the fabric. Some fabrics, for instance, can be highly absorptive of aqueous inks, which can diminish color characteristics of the printed image. Other fabrics, such as some synthetic fabrics, can be crystalline, and thus are less absorptive of aqueous inks. When the inks are not adequately absorbed, performance issues can result. These characteristics (e.g., diminished color, ink bleed) can result in poor image quality on the respective fabrics. The challenge for inkjet textile printing can also come from, for example, image quality and image durability during daily use such as laundry with detergent. To improve the performance, a process as called “pre-treatment” can be applied during printing. The pre-treatment refers to apply a special formulated chemical composition to the textile substrate prior to printing. Specifically, in this disclosure, the pre-treatment refers to apply the special formulated chemical composition by an analog method such as padding, rolling and spraying to the textile substrate and drying, before the textile being inkjet printed. The inkjet printing is completed based on a “wet-and-dry” basis.

The pre-treatment can also be called and referred to as coating composition. Such coating composition is indeed coated on a base substrate. In some example, the coating composition is coated onto a fabric base substrate and is thus called fabric coating composition. The term “coating” and “coated” is used herein to describe the coating composition, or to describe a composition applied to a surface of a fabric substrate. However, it is noted that the terms “coating” or “coated” may or may not indicate the presence of a continuous layer of a composition applied on top of the fabric substrate as a discrete layer, but rather can more typically be similar in nature to a surface treatment that may penetrate the fabric substrate surface in some examples and/or alter the surface chemistry of the fabric substrate. Thus, the terms “coating” and “coated” should be interpreted to include compositions that modify the surface of the fabric substrate in some manner, either by a separate layer of material or by surface modification or treatment of the fabric substrate.

The present disclosure relates to a coating composition, also called herein coating composition or pre-treatment composition, and the method to apply such pre-treatment on textile substrate. The coating composition comprises from 2 to 50 dry parts of a crosslinking polymer, from 5 to 60 dry parts of a polymeric binder; from 2 to 30 dry parts of pigment fixation agents, parts are based on total dry content of the coating composition; a pH control agent in an amount adjusted to have a pH above 7; and an aqueous liquid vehicle. The pre-treatment composition, also called herein coating composition is a fabric coating composition meaning thus that it is used to be applied, i.e. coated, to a fabric print medium.

The present disclosure also relates to a coated fabric print medium, comprising a fabric base substrate and a coating layer applied on, at least, one side of the fabric base substrate, the coating layer including from 2 to 50 dry parts of a crosslinking polymer, from 5 to 60 dry parts of a polymeric binder; from 2 to 30 dry parts of pigment fixation agents based on the total dry content of the coating composition; a pH control agent in an amount adjusted to have a pH above 7; and an aqueous liquid vehicle. The coated fabric print medium can include a fabric substrate and a coating layer on the fabric substrate having a 0.5 gsm to 10 gsm dry coating weight basis.

The present disclosure also relates to a method for forming the coated fabric printable medium as described therein. Also described herein is a method of textile printing includes ejecting an ink composition onto a coated fabric print medium. The coated fabric print medium includes a fabric substrate, and a coating layer on the fabric substrate. The coated layer has a 0.5 gsm to 10 gsm dry coating weight basis, and comprises from 2 to 50 dry parts of a crosslinking polymer, from 5 to 60 dry parts of a polymeric binder; from 2 to 30 dry parts of pigment fixation agents based on 100 parts of total dry content of the coating composition; a pH control agent in an amount adjusted to have a pH above 7; and an aqueous liquid vehicle.

In some examples, the aqueous liquid vehicle, such as deionized (DI) water, is added in an amount to obtain a pre-treatment composition having between 2 to 25% of solid content (dry weight percent).

It is observed that the application of the pre-treatment composition according to the present disclosure on a fabric substrate, significantly increases the image quality and the image durability of the image printed on the coated media comprising the pre-treatment composition (or coating composition) described herein. Regardless of the substrate, whether natural, synthetic, blends thereof, treated, untreated, etc., the fabric substrates coated with the pre-treatment composition of the present disclosure can provide acceptable optical density (OD) and/or washfastness properties.

The term “wash-fastness” can be defined as the OD that is retained or delta E (ΔE) after standard washing machine cycles using warm water and a standard clothing detergent (e.g., Tide® available from Proctor and Gamble, Cincinnati, Ohio, USA). Essentially, by measuring OD and/or L*a*b* both before and after washing, ΔOD and ΔE value can be determined, which is essentially a quantitative way of expressing the difference between the OD and/or L*a*b* prior to and after undergoing the washing cycles. Thus, the lower the ΔOD and ΔE values, the better. In further detail, ΔE is a single number that represents the “distance” between two colors, which in accordance with the present disclosure, is the color (or black) prior to washing and the modified color (or modified black) after washing. Colors, for example, can be expressed as CIELAB values. It is noted that color differences may not be symmetrical going in both directions (pre-washing to post washing vs. post-washing to pre-washing). Using the CIE 1976 definition, the color difference can be measured and the ΔE value calculated based on subtracting the pre-washing color values of L*, a*, and b* from the post-washing color values of L*, a*, and b*. Those values can then be squared, and then a square root of the sum can be determined to arrive at the ΔE value.

In the present specification and in the appended claims, the components of the formulations can be expressed in terms of dry parts, with the total dry parts of dry the pre-treatment composition, in a given formulation, set to 100 dry parts. Other coating components are expressed in parts as a ratio to 100 parts of total content of the pre-treatment composition.

Crosslinking Polymer

The fabric coating composition or fabric pre-treatment composition comprises crosslinking polymer also called herein cross-linker. It is believed that said crosslinking polymer can cross-link binders that are present in ink compositions that would be jetted to the media substrate during the printing process. Such reaction will happen at low-temperature and will provide excellent print durability.

In some examples, the coating composition includes from 2 to 50 dry parts of a crosslinking polymer including a plurality of imine-type groups. The crosslinking polymer can be a polyimine, a polycarbodiimide, a mixture of polyimine and polycarbodiimide, or a polymer that is both a polyimine and a polycarbodiimide.

The crosslinking polymer substances are present in an amount ranging from about 2 to about 50 dry parts of the total dry content of the fabric coating composition. In some other examples, the crosslinking polymers are present in an amount ranging from about 3 to about 25 dry parts or from about 2 to about 15 dry parts based on the total dry content of the coating composition.

In some examples, the crosslinking polymer includes a polyimine including a plurality of imine-type groups. In some other examples, the crosslinking polymer includes a polyimine including multiple imine groups, wherein the polyimine has a weight average molecular weight of from 1,000 Mw to 150,000 Mw.

The crosslinking polymer can be also a polycarbodiimide reactive substance. In some other examples, wherein the polycarbodiimide crosslinking polymer has multiple carbodiimide groups and has a weight average molecular weight of from 1,000 Mw to 150,000 Mw.

In some examples, the crosslinking polymer can include multiple imine-type groups, such as imine group(s), carbodiimide group(s), or a combination thereof. As an initial point of clarification, when referring to the “imine-type group(s)” of the crosslinking polymer, this can include groups based on nitrogen double bonded to carbon without other heteroatoms directly bonded to the nitrogen or the carbon, e.g., imine (N═C) or carbodiimide (N═C═N). Other heteroatoms can be part of the crosslinking polymer, but there would be a carbon on either side of the imine-type group. A polycarbodiimide, for example, is considered to include imine-type groups because it has multiple carbodiimide moieties, which includes nitrogen double-bonded to carbon (and the carbon is further double-bonded to another nitrogen (N═C═N)). As there is no heteroatom present as part of this crosslinking group, it is considered to be an imine-type group. For contrast, a polyisocyanate group would not be considered to be an imine-type group because of the presence of the other type of heteroatom that is present, e.g., oxygen (N═C═O). Thus, the term “imine-type group” should be interpreted to mean any crosslinking polymer that is based on nitrogen double-bonded to a carbon with no other type of heteroatom (e.g., oxygen, sulfur, etc.) being bonded immediately adjacent to any N═C moiety of the imine-type group.

In further detail, when referring to crosslinking polymers with “a plurality of imine-type groups,” this can include “polyimines” indicating the presence of multiple imine (N═C) groups, “polycarbodiimides” indicating the presence of multiple carbodiimide (N═C═N) groups, and/or crosslinking polymers with both imine groups and carbodiimide groups. As a note, a crosslinking polymer with one imine group and one carbodiimide group is neither a polyimine nor a polycarbodiimide, but would still be considered to include a plurality of imine-type groups. Furthermore, a crosslinking polymer with multiple imine groups and multiple carbodiimide groups is considered to be a polyimine and a polycarbodiimide.

The crosslinking polymer, for example, can have a weight average molecular weight of from 1,000 Mw to 100,000 Mw, from 1,000 Mw to 75,000 Mw, from 1,000 Mw to 50,000 Mw, from 2,000 Mw to 100,000 Mw, from 2,000 Mw to 50,000 Mw, from 5,000 Mw to 100,000 Mw, from 5,000 Mw to 50,000 Mw, from 5,000 Mw 40,000 Mw, from 5,000 Mw to 30,000 Mw, or from 5,000 Mw to 20,000 Mw, for example. This is the case for both polyimines, polycarbodiimides, and polymers with both imine and carbodiimide groups. These crosslinking polymers can be aliphatic and/or aromatic polymers and can include heteroatoms that do not impact the nature of multiple imine-type groups of the polymer, as outlined previously.

A general structure for a polyimine is shown below in Formula I, as follows:

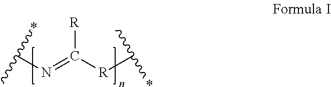

where individual R groups along the crosslinking polymer chain independently includes C1 to C15 alkyl, C3 to C15 alicyclic, C5 to C15 aromatic, heteroatom substitutes thereof, or a combination thereof. A “heteroatom” is defined herein as nitrogen, oxygen, and/or sulfur. A heteroatom substitute, if present, is not directly attached to the nitrogen or the carbon of the imine group. The balance of the crosslinking polymer notated by an asterisk (*) indicates a continuation of the crosslinking polymer. The crosslinking polymer may include other groups not specifically indicated in Formula I, such as urethane groups, carbodiimide groups, etc. The variable “n” in this example is an integer from 2 to 1,000, from 4 to 500, or from 10 to 250, for example. Furthermore, Formula I does not infer that the imide group and other constituents between the brackets repeats consecutively, as there is typically a carbon atom on either side of the bracketed group shown. Formula I also does not infer that the R groups would be identical to one another within one polymeric unit within the bracket, nor does it infer that the R groups would be identical at the various polymeric units along the polymer chain, though they may be in one example.

A general structure for a polycarbodiimide is shown below in Formula II, as follows:

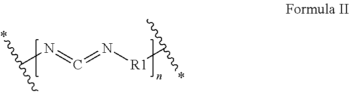

wherein R along the crosslinking polymer chain independently includes C1 to C15 alkyl, C3 to C15 alicyclic, C5 to C15 aromatic, heteroatom substitutes thereof, or a combination thereof. A heteroatom substitute, if present, is not directly attached to the nitrogen or the carbon of the imine group. The balance of the crosslinking polymer notated by an asterisk (*) indicates a continuation of the crosslinking polymer. The crosslinking polymer may include other groups not specifically indicated in Formula II, such as urethane groups, carbodiimide groups, etc. The variable “n” in this example is an integer from 2 to 1,000, from 4 to 500, or from 10 to 250, for example. Furthermore, Formula II does not infer that the imide group and other constituents between the brackets repeats consecutively, as there is typically a carbon atom on either side of the bracketed group shown. Formula II also does not infer that the R groups would be identical to one another within one polymeric unit within the bracket, nor does it infer that the R groups would be identical at the various polymeric units along the polymer chain, though they may be in one example.

The polyimine or the polycarbodiimide can, as mentioned, include other components or even other polymer types copolymerized therewith. For example, the polyimines and/or polycarbodiimides can include urethane caps and/or polyurethane portions. Two more specific example structures for a polyimine-polyurethane hybrid and a polycarbodiimide-polyurethane hybrid are shown in Formula III and in Formula IV, respectively, as follows:

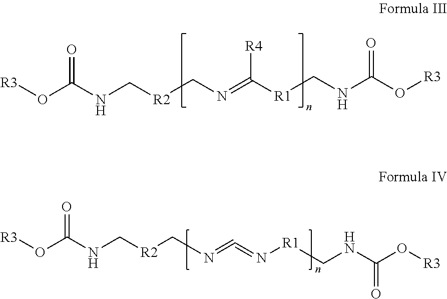

wherein R1-R4 along the crosslinking polymer chain independently be or include C1 to C15 alkyl, C3 to C15 alicyclic, C5 to C15 aromatic, heteroatom substitutes thereof, or a combination thereof. Furthermore, R2-R4 can also independently be or include a urethane group and/or a carbodiimide group, or even a polyurethane oligomer or polymer. The variable “n” in this example is an integer from 2 to 1,000, from 4 to 500, or from 10 to 250, for example.

In some examples, the fabric coating composition or fabric pre-treatment composition comprise polycarbodiimide cross-linkers. The polycarbodiimide cross-linkers that are used herein do not release any formaldehyde compounds, they are formaldehyde-free: the products afforded from such crosslinking agents and the processes by which these products are manufactured, comply thus with the strictest standards for consumer products and good manufacturing practices.

In some example, the polycarbodiimide cross-linkers have a weight average molecular weight in the range of 1,500 Mw to 150,000 Mw, from 2,000 Mw to 100,000 Mw, or from 5,000 Mw to 75,000 Mw.

Polycarbodiimide (PCDI) cross-linkers contain carbodiimide reactive group, sometimes combined with other functional reactive groups. Polycarbodiimides (PCDI) are considered to be oligomers or polymers containing on average two or more carbodiimide groups.

The polycarbodiimide cross-linkers can be any of a number of polycarbodiimides with two or more carbodiimide groups. In some examples, when the fabric coating composition with said crosslinker is applied to a fabric media and printed with an ink composition, the urethane and (meth)acrylic acid group(s) (such as provided by the aromatic (meth)acrylate moieties or other (meth)acrylates that may be present at a surface of a polymer latex present in the ink composition), the polycarbodiimide cross-linkers of the coating composition, and in some instances, the surface of the fabric media substrate can interact to generate a high quality image that exhibits durable washfastness as demonstrated in the examples hereinafter.

The formula V below illustrate cross-linking mechanism of polycarbodiimide with polymer binders that could be found in inks composition that would be applied to the coated fabric media. In more details, the formula V below illustrates a non-limiting example of a reaction between i) a carboxylic acid group, that can be present in the ink, on a surface of a latex polymer (also in salt and/or ester form in equilibrium), and ii) a carbodiimide group, present on a polycarbodiimide that can be part of fabric coating composition.

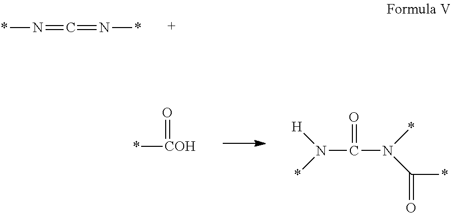

In Formula V, the asterisks (*) represent portions of the various organic compounds that are not part of the reaction shown in Formula V, and are thus not shown, but could be any of a number of organic groups or functional moieties, for example.

As illustrated in Formula V, the chemistry of polycarbodiimide crosslinking involves mainly the reaction of carboxylic acid residues (—COOH) in acrylic resins or in polyurethane dispersions with carbodiimide (—N═C═N—) groups of the crosslinker. After the formation of an unstable intermediate, a stable N-acylurea is formed. Since the Polycarbodiimide (PCDI) contains several —N═C═N— groups, one carbodiimide (CDI) molecule can react with carboxylic acid residues on different polymer chains tying them together forming a three-dimensional network. Reaction of carboxylic acid with carbodiimide can be quite fast under ambient or mild thermal curing conditions.

In some other examples, polycarbodiimide can react with carboxylic acid groups, alcohols and amine functional groups. The first step will be the reaction of —COOH with —N═C═N that will form an unstable intermediate, which then form more stable acylurea, or it can further react with carboxylic acid, alcohol or amines to further form cross-linked network. Polycarbodiimide crosslinker can cross-link acidic groups, but also cross-link hydroxyl and amine groups in the polymer binders, which can further enhance the durability.

In further detail, in accordance with examples of the present disclosure, the polycarbodiimides present in the crosslinker composition can interact with the latex polymer that are present in ink formation, acting to cause the (meth)acrylate (or (meth)acrylic acid) group of the polymer binder to form an amide linkage, as shown in Formula V above. Other types of reactions can also occur, but Formula V is provided by way of example to illustrate one type of reaction that can occur when the ink composition comes into contact with the crosslinker composition, e.g., interaction or reaction with the substrate, interaction or reaction between different types of latex polymer and/or different types of polycarbodiimides, interactions or reactions with different molar ratios (other than 1:1, for example) than that shown in Formula V.

Considering in further detail polycarbodiimides in particular as an example, as mentioned, these crosslinking polymers include multiple carbodiimide reactive groups, e.g., an average of 2 or more carbodiimide groups. However, as mentioned, they can also be combined with other functional reactive groups. Thus, there are multifunctional water-dispersible polycarbodiimides that provide high levels of crosslinking.

A non-limiting example of such, polycarbodiimide based crosslinking agents includes Carbodilite® (from Nashinbo, Japan) such as Carbodilite® SV 02, V-02, V-02-L2 and/or E-02. Other non-limiting example of polycarbodiimide based crosslinking agents includes Picassian® XL-702 and Picassian® XL-732 from Stahl Polymers. One particular example of Carbodilite polycarbodiimides is Carbodilite® SV-02. Carbodilite® SV-02 is water-based VOC free crosslinking agent. It is a non-toxic, polycarbodiimide based crosslinking agent which helps improve waterborne resins various attributes such as water, solvent, and chemical resistance. It also improves hardness, abrasion, scratch resistance. It reacts with carboxyl group even in room temperature, with dosage low as 3˜7 wt %. Its key benefits include: non-toxic, excellent performance at low temperature cure, good alkali resistance, and excellent dispersibility.

Polymeric Compounds

The fabric coating composition, or fabric pre-treatment composition, comprises polymeric compounds and/or a mixture of polymeric compounds, also called herein binder. The polymeric compounds are present in an amount ranging from about 5 to about 60 dry parts of the total dry content of the coating composition. In some examples, the polymeric compounds are present in an amount ranging from about 10 to about 40 dry parts or from about 15 to about 30 dry parts based on the total dry content of the coating composition.

The glass transition temperature (Tg) of the polymeric compounds, or the glass transition temperature of polymeric compounds in the mixture is less than 0° C. By “the glass transition temperature” (Tg) of polymeric compounds in the mixture is less than 0° C., it is meant herein that the majority or nearly all polymeric compounds present in the mixture will have a glass transition temperature that is less than 0° C.

Glass transition temperature (Tg) of polymeric compounds can be measured using differential scanning calorimetry according to ASTM D6604: Standard Practice for Glass Transition Temperatures of Hydrocarbon Resins by Differential Scanning calorimetry. Differential scanning calorimetry can be used to measure the heat capacity of the polymer across a range of temperatures. The heat capacity can jump over a range of temperatures around the glass transition temperature. The glass transition temperature itself can be defined as the temperature where the heat capacity is halfway between the initial heat capacity at the beginning of the jump and the final heat capacity at the end of the jump.

In some example, the polymeric compound is selected from the group consisting of polyurethane and polyurethane derivative such as vinyl-urethane, acrylic urethane, polyurethane-acrylic, polyether polyurethane, polyester polyurethane, polycaprolactam polyurethane, polyether polyurethane, and a combination.

In one example, the polymeric compound can be a polyurethane polymer or polyurethane polymeric compound. The polyurethane polymer can be formed by reacting an isocyanate with a polyol. Example isocyanates used to form the polyurethane polymer can include toluene di-isocyanate, 1,6-hexamethylenediisocyanate, diphenylmethanedi-isocyanate, 1,3-bis(isocyanatemethyl)cyclohexane, 1,4-cyclohexyldiisocyanate, p-phenylenediisocyanate, 2,2,4(2,4,4)-trimethylhexamethylenediisocyanate, 4,4′-dicychlohexylmethanediisocyanate, 3,3′-dimethyldiphenyl, 4,4′-diisocyanate, m-xylenediisocyanate, tetramethylxylenediisocyanate, 1,5-naphthalenediisocyanate, dimethyl-triphenyl-methane-tetra-isocyanate, triphenyl-methane-tri-isocyanate, tris(iso-cyanate-phenyl)thiophosphate, and combinations thereof. Commercially available isocyanates can include Rhodocoat® WT 2102 (available from Rhodia AG), Basonat® LR 8878 (available from BASF), Desmodur® DA, and Bayhydur® 3100 (Desmodur® and Bayhydur® are available from Bayer AG). Example polyols used to form the polyurethane polymer can include 1,4-butanediol, 1,3-propanediol, 1,2-ethanediol, 1,2-propanediol, 1,6-hexanediol, 2-methyl-1,3-propanediol, 2,2-dimethyl-1,3-propanediol, neopentyl glycol, cyclo-hexane-dim ethanol, 1,2,3-propanetriol, 2-ethyl-2-hydroxymethyl-1,3-propanediol, and combinations thereof.

In some examples, the isocyanate and the polyol can have less than three functional end groups per molecule. In another example, the isocyanate and the polyol can have less than five functional end groups per molecule. In yet another example, the polyurethane can be formed from a polyisocyanate having at least two isocyanate functionalities (—NCO) per molecule and at least one isocyanate reactive group (e.g., such as a polyol having at least two hydroxyl or amine groups). Example polyisocyanates can include diisocyanate monomers and oligomers. The self-crosslinked polyurethane polymer can also be formed by reacting an isocyanate with a polyol, where both isocyanates and polyols have an average of less than three end functional groups per molecule so that the polymeric network is based on a linear polymeric chain structure. In one example, the polyurethane can be prepared with a NCO/OH ratio ranging from about 1.2 to about 2.2. In another example, the polyurethane can be prepared with a NCO/OH ratio ranging from about 1.4 to about 2.0. In yet another example, the polyurethane can be prepared using an NCO/OH ratio ranging from about 1.6 to about 1.8.

In one example, the average molecular weight of the polyurethane polymeric compound can range from about 20,000 Mw to about 200,000 Mw as measured by gel permeation chromatography. In another example, the weight average molecular weight of the polyurethane polymeric compound can range from about 40,000 Mw to about 180,000 Mw as measured by gel permeation chromatography. In yet another example, the weight average molecular weight of the polyurethane polymeric compound can range from about 60,000 Mw to about 140,000 Mw as measured by gel permeation chromatography.

In some examples the polyurethane can be aliphatic or aromatic. In one example, the polyurethane can include an aromatic polyether polyurethane, an aliphatic polyether polyurethane, an aromatic polyester polyurethane, an aliphatic polyester polyurethane, an aromatic polycaprolactam polyurethane, an aliphatic polycaprolactam polyurethane, or a combination thereof. In another example, the polyurethane can include an aromatic polyether polyurethane, an aliphatic polyether polyurethane, an aromatic polyester polyurethane, an aliphatic polyester polyurethane, and a combination thereof. Exemplary commercially-available examples of these polyurethanes can include; NeoPac® R-9000, R-9699, and R-9030 (available from Zeneca Resins, Ohio), Printrite® DP376 and Sancure® AU4010 (available from Lubrizol Advanced Materials, Inc., Ohio), and Hybridur® 570 (available from Air Products and Chemicals Inc., Pennsylvania), Sancure® 2710, Avalure® UR445 (which are equivalent copolymers of polypropylene glycol, isophorone diisocyanate, and 2,2-dimethylolpropionic acid, having the International Nomenclature Cosmetic Ingredient name “PPG-17/PPG-34/IPDI/DMPA Copolymer”).

Some specific examples of commercially available aliphatic waterborne polyurethanes include Sancure® 1514, Sancure® 1591, Sancure® 2260, and Sancure® 2026 (all of which are available from Lubrizol Inc.). Some specific examples of commercially available castor oil-based polyurethanes include Alberdingkusa® CUR 69, Alberdingkusa® CUR 99, and Alberdingkusa® CUR 991 (all from Alberdingk Boley Inc.).

Other examples of the polyurethane polymeric compound that can be used include vinyl-urethane, acrylic urethane, polyurethane-acrylic, polyether polyurethane, polyester polyurethane, polycaprolactam polyurethane, or polyether polyurethane. Any of these examples may be aliphatic or aromatic. For example, the polyurethane may include aromatic polyether polyurethanes, aliphatic polyether polyurethanes, aromatic polyester polyurethanes, aliphatic polyester polyurethanes, aromatic polycaprolactam polyurethanes, or aliphatic polycaprolactam polyurethanes.

In some examples, the polymeric compound that can be used include vinyl-urethane, acrylic urethane, polyurethane-acrylic is formed by using vinyl-urethane hybrid copolymers or acrylic-urethane hybrid copolymers. In yet some other examples, the polymeric network(s) includes an aliphatic polyurethane-acrylic hybrid polymer. Representative commercially available examples of the chemicals which can form an acrylic-urethane polymeric network include NeoPac® R-9000, R-9699 and R-9030 (from Zeneca Resins) or HYRBIDUR™ 570 (from Air Products and Chemicals). In still another example, the polymeric network includes an acrylic-polyester-polyurethane polymer, such as Sancure® AU 4010 (from Lubrizol Inc.).

In some examples, any example of the polymeric compound can include a polyether polyurethane. Representative commercially available examples of the chemicals which can form a polyether-urethane polymeric network include Alberdingkusa® U 205, Alberdingkusa® U 410, and Alberdingkusa® U 400N (all from Alberdingk Boley Inc.), or Sancure® 861, Sancure® 878, Sancure® 2310, Sancure® 2710, Sancure® 2715, or Avalure® UR445 (equivalent copolymers of polypropylene glycol, isophorone diisocyanate, and 2,2-dimethylolpropionic acid, having the International Nomenclature Cosmetic Ingredient name “PPG-17/PPG-34/IPDI/DMPA Copolymer” (all from Lubrizol Inc.).

In other examples, any example of the polymeric compound can include a polyester polyurethane. Representative commercially available examples of the chemicals which can form a polyester-urethane polymeric network include Alberdingkusa® 801, Alberdingkusa® u 910, Alberdingkusa® u 9380, Alberdingk® u 2101 and Alberdingk® u 420 (all from Alberdingk Boley Inc.), or Sancure® 815, Sancure® 825, Sancure® 835, Sancure® 843c, Sancure® 898, Sancure® 899, Sancure® 1301, Sancure® 1511, Sancure® 2026c, Sancure® 2255, and Sancure® 2310 (all from Lubrizol, Inc.). In still other examples, any example of the polymeric compound can include a polycarbonate polyurethane. Examples of polycarbonate polyurethanes include Alberdingkusa® U 933 and Alberdingkusa® U 915 (all from Alberdingk Boley Inc.).

In some examples, the polymeric compounds used to make pre-treatment include rubber emulsion/latex. The types of rubber emulsion/latex include, but are not limited to, natural Rubber (NR) or linear polymer of polyisoprene, Styrene Butadiene Rubber (SBR), Nitrile Rubber or copolymer of acrylonitrile and butadiene, Neoprene Rubber or polychloroprene, EPDM Rubber or copolymer of ethylene, propylene with dienes such as dicyclopentadiene (DCPD), ethylidene norbornene (ENB), and vinyl norbornene (VNB), Butyl Rubber (BR), or copolymer of isobutylene with isoprene, polychloroprene rubber, polysiloxane rubber and chloro-sulphonated polyethylene/rubber.

In one example, the polymeric compounds can include a polyacrylate (i.e., a polyacrylate based polymer). Examples of polyacrylates include polymers made by hydrophobic addition monomers, such as C1-C12 alkyl acrylates, carboxylic containing monomers (e.g., acrylic acid, methacrylic acid), vinyl ester monomers (e.g., vinyl acetate, vinyl propionate, vinyl benzoate, vinyl pivalate, vinyl-2-ethylhexanoate, vinyl versatate, etc.), vinyl benzene monomer, C1-C12 alkyl acrylamide and methacrylamide (e.g., t-butyl acrylamide, sec-butyl acrylamide, N,N-dimethylacrylamide, etc.), crosslinking monomers (e.g., divinyl benzene, ethylene glycol dimethacrylate, bis(acryloylamido)methylene, etc.), and combinations thereof. As specific examples, polymers made from the polymerization and/or copolymerization of alkyl acrylate, alkyl methacrylate, and/or vinyl esters may be used. Any of the listed monomers (e.g., hydrophobic addition monomers, aromatic monomers, etc.) may be copolymerized with styrene or a styrene derivative. As specific examples, polymers made from the copolymerization of alkyl acrylate, alkyl methacrylate, and/or vinyl esters, with styrene or styrene derivatives may also be useful. The polymeric compound of polyacrylate based polymer having a glass transition temperature less than 0° C.

Pigment Fixation Agent

The fabric coating composition or fabric pre-treatment composition comprises a pigment fixation agent. The fixation agent also includes a mixture of fixation agents. The pigment fixation agents are present in an amount representing from about 2 to about 30 dry parts of the total dry content of the coating composition. In some examples, the pigment fixation agents are present in an amount ranging from about 5 to about 20 dry parts of the total dry content of the coating composition.

The pigment fixation agents would help crushing and binding the ink pigment colorants to improve printing image and printing image durability. In some examples, the pigment fixation agent is metallic salt ink fixation agent or mixture of metallic salt. The pigment fixation can be a water-soluble or water-dispersible metallic salt.

The metallic salts may include mono- or multi-valent metallic salts. In some examples, pigment fixation agent is multivalent metallic salt. The metallic salt may include cations, such as Group I metals, Group II metals, Group III metals, or transition metals, such as sodium, calcium, copper, nickel, magnesium, zinc, barium, iron, aluminum and chromium ions. An anion species can be chloride, iodide, bromide, nitrate, sulfate, sulfite, phosphate, chlorate, acetate ions, or various combinations. The metallic salt can be selected from inorganic metallic salts, such as calcium chloride, calcium nitrite, calcium sulfate, magnesium bromide; magnesium chloride, magnesium chlorate; magnesium sulfate; magnesium nitrate; magnesium perchlorate; magnesium fluorosilicate, aluminum sulfate, aluminum chloride; aluminum chloride, aluminum nitrate, aluminum chloride hydroxide (Al₂Cl(OH)₅).

Alternatively, the metallic salt can be selected from organic acid metallic salts and its hydrates such as calcium acetate, calcium citrate, calcium acamprosate, calcium adipate, calcium benzoate, calcium formate, calcium isoascorbate, calcium malate, calcium propionate, calcium lactate; magnesium acetate, magnesium acetate tetrahydrate, magnesium aspartate tetrahydrate, trimagnesium dicitrate nonadydrate, trimagnesium dicitrate tetradecanehydrate, tricalcium dicitrate tetrahydrate, calcium acetate tetrahydrate, magnesium stearate, magnesium alkylsalieylate, magnesium alkylphenolate, magnesium hydroxystearate, magnesium oleate, and aluminum lactate.

A pH Control Agent

The fabric coating composition or fabric pre-treatment composition comprises a pH control agent. The pH control agent is present in an amount sufficient to have alkaline fabric coating composition. In other word, the pH control agent is present in an amount sufficient to have pH value greater than 7. Indeed, it has been found that pH of the pre-treatment composition is critical to the effectiveness of the its functionality. In one example, the pH of the pre-treatment composition is alkaline with a pH value greater than 7, and in another example, the pH value of the pre-treatment composition is alkaline with a pH greater than 8.

Any chemical compounds which can provide free OH⁻ ions can be used for this purpose. The examples are, but not limited to, caustic potash (potassium hydroxide), caustic soda (sodium hydroxide), ammonium hydroxide —NH₄OH, Lime (calcium hydroxide), magnesium hydroxide —Mg(OH)₂, NaHCO₃, soda ash (sodium carbonate) and pH puffers which can establish alkalinity and resist pH changes up to a high pH level up to 10, such as commercial product Buff-10 from Tetra Inc.

The ink compositions of the present disclosure can be formulated to include an aqueous liquid vehicle, which can include the water content, e.g., 60 wt % to 90 wt % or from 75 wt % to 85 wt %, as well as organic co-solvent, e.g., from 4 wt % to 30 wt %, from 6 wt % to 20 wt %, or from 8 wt % to 15 wt %. Other liquid vehicle components can also be included, such as surfactant, antibacterial agent, other colorants, etc. However, as part of the ink composition, pigment, dispersant, and the latex polymer can be included or carried by the liquid vehicle components. Suitable pH ranges for the ink composition can be from pH 7 to pH 11, from pH 7 to pH 10, from pH 7.2 to pH 10, from pH 7.5 to pH 10, from pH 8 to pH 10, 7 to pH 9, from pH 7.2 to pH 9, from pH 7.5 to pH 9, from pH 8 to pH 9, or from pH 8 to pH 8.5.

Fabric Base Substrate

The coating composition described herein is designed to be applied on a fabric base substrate. The fabric coating composition is indeed a pre-treatment composition designed to be applied, i.e. to pre-treat, a media substrate and more specifically a fabric media substrate. It is notable that the term “fabric substrate” or “fabric media substrate” does not include materials commonly known as any kind of paper (even though paper can include multiple types of natural and synthetic fibers or mixtures of both types of fibers).

Thus, textiles and fabrics can be treated with the coating compositions of the present disclosure, including cotton fibers, treated and untreated cotton substrates, polyester substrates, nylons, silk, blended substrates thereof, etc. It is notable that the term “fabric substrate” or “fabric media substrate” does not include materials such as any paper (even though paper can include multiple types of natural and synthetic fibers or mixtures of both types of fibers). Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources such as cornstarch, tapioca products, or sugarcanes, etc. Example synthetic fibers that can be used include polymeric fibers such as nylon fibers (also referred to as polyamide fibers), polyvinyl chloride (PVC) fibers, PVC-free fibers made of polyester, polyamide, polyimide, polyacrylic, polypropylene, polyethylene, polyurethane, polystyrene, polyaramid, e.g., Kevlar® (E. I. du Pont de Nemours Company, USA), polytetrafluoroethylene, fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both of the polymeric fiber and a surface of the fabric, a plasma treatment, a solvent treatment, acid etching, or a biological treatment, an enzyme treatment, or antimicrobial treatment to prevent biological degradation.

Thus, the fabric substrate can include natural fiber and synthetic fiber, e.g., cotton/polyester blend. The amount of the various individual fiber types can vary. For example, the amount of the natural fiber can vary from about 5 wt % to about 95 wt % and the amount of synthetic fiber can range from about 5 wt % to 95 wt %. In yet another example, the amount of the natural fiber can vary from about 10 wt % to 80 wt % and the synthetic fiber can be present from about 20 wt % to about 90 wt %. In other examples, the amount of the natural fiber can be about 10 wt % to 90 wt % and the amount of synthetic fiber can also be about 10 wt % to about 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa.

The fabric substrate can be in one of many different forms, including, for example, a textile, a cloth, a fabric material, fabric clothing, or other fabric product suitable for applying ink, and the fabric substrate can have any of a number of fabric structures, including structures that can have warp and weft, and/or can be woven, non-woven, knitted, tufted, crocheted, knotted, and pressured, for example. The terms “warp” as used herein, refers to lengthwise or longitudinal yarns on a loom, while “weft” refers to crosswise or transverse yarns on a loom.

In some examples, the textile substrate used in this application can be made of any kind of natural and synthetic fabric. In one example, it is cotton textile, include, but not limited to, regular plant cotton, organic cotton, pima cotton, supima cotton and slub cotton. In other examples, it can be made of other textile substrates such as Linen (from the flax plant and has a textured weave), Lycra® (made of spandex. Spandex®, or Lycra®). Further, in other examples, it is the synthetic textile such as polyester, or man-made fiber created from natural trees, cotton, and plants such as rayon. Further in another example, it can be the mixture of both natural fabrics and synthetic fabrics such polyester and cotton 50%/50% blended fabric textile, or tri-blends made up of 3 different types of material which is generally polyester, cotton and rayon. In some examples, the textile substrate may be selected from the same yarn materials such cotton but very different structurally due to weaving method. The material that can be used are, for example, plain weave cotton, end-on-end weave, voile weave, twill weave, Oxford weave. In some examples, it can be made by knitted method using the yarns listed above, or special knitted such as scuba double-knit fabric textile which is usually made of polyester mixed with either Lycra® or Spandex®.

In one example, the fabric substrate can have a basis weight ranging from about 100 gsm to about 500 gsm. In another example, the fabric substrate can have a basis weight ranging from about 105 gsm to about 400 gsm. In other examples, the fabric substrate can have a basis weight ranging from about 120 gsm to about 300 gsm, from about 130 gsm to about 200 gsm, from about 150 gsm to about 200 gsm, or from about 175 gsm to about 250 gsm.

Method for Forming the Fabric Printable Medium

Method for forming a coated fabric printable medium are disclosed herein. Such method comprised providing a fabric base substrate and applying the fabric coating composition or pre-treatment composition as described herein in order to pre-treat the fabric textile in order to obtain a coated fabric print medium that could be printed.

When applying the coating composition to a fabric substrate, the coating composition can be applied to any media substrate type using any method appropriate for the coating application properties, e.g., grams per square meter (gsm), viscosity, etc. Application of the coating composition to the fabric substrate can be at from 0.5 gsm to 10 gsm, from 0.5 gsm to 8 gsm, or from 1 gsm to 8 gsm, from 1 gsm to 5 gsm, without being limiting. The viscosity of the coating composition, for example, can be similar to that of water or slightly higher if applied as a solution using a sprayer, e.g., about 1 centipoise (cps) to about 100 cps or about 2 cps to about 50 cps at 20° C., or it can have a higher viscosity in some examples, e.g., from about 100 cps to about 1,000 cps or from about 200 cps to 1,000 cps at 20° C. Other non-limiting examples of coating methods include paddler size press, slot die, blade coating, and Meyer rod coating, dip coating, etc. In one example, any of a variety of spray coating methods may be used with the present embodiment. In one example, the fabric substrate can be passed under an adjustable spray nozzle. The adjustable spray nozzle may be configured to alter the rate at which the pre-treatment solution is sprayed onto the fabric substrate. By adjusting factors such as the rate at which the fabric substrate is passed under the nozzle, the rate at which the composite solution is sprayed on the fabric, the distance of the fabric substrate from the nozzle, the spraying profile of the nozzle, and/or the concentration of the pre-treatment solution, a coating composition may be applied for any of a number of applications.

Furthermore, the application of the coating composition can be carried out using padding procedures. The fabric substrate can be soaked in a bath and the excess can be rolled out. More specifically, impregnated fabric substrates (prepared by bath, spraying, dipping, etc.) can be passed through padding nip rolls under pressure. The impregnated fabric, after nip rolling, can then be dried under heat at any functional time which is controlled by machine speed with peak fabric web temperature. In some examples, pressure can be applied to the fabric substrate after impregnating the fabric base substrate with the pre-treatment composition. In some other examples, the surface treatment is accomplished in a pressure padding operation. During such operation, the fabric base substrate is firstly dipped into a pan containing treatment coating composition and is then passed through the gap of padding rolls. The padding rolls (a pair of two soft rubber rolls or a metal chromic metal hard roll and a tough-rubber synthetic soft roll for instance), apply the pressure to composite-wetted textile material so that composite amount can be accurately controlled. In some examples, the pressure that is applied can be from 10 PSI to 150 PSI or, in some other examples, can be from 30 PSI to 70 PSI.

The composition can be dried using box hot air dryer or another drying methodology. The dryer can be a single unit or could be in a serial of 3 to 7 units so that a temperature profile can be created with initial higher temperature (to remove excessive water) and mild temperature in end units (to ensure completely drying with a final moisture level of less than 1-5% for example). The dryer temperature can be programmed into a profile with higher temperature at the beginning of the drying when wet moisture is higher, and then reduced to lower temperature as the coating composition becomes drier, though other drying profiles can likewise be used. The dryer temperature can be controlled to a temperature of less than about 100° C. in one example, and in other examples, the operation speed of the padding/drying line can be from 10 yards/minute to 100 yards/minute, though speeds outside of this range can also be used.

Printing Method

The printing method comprises: obtaining a fabric printable medium including a fabric base substrate and coating composition, comprising from 2 to 50 dry parts of a crosslinking polymer, from 5 to 60 dry parts of a polymeric binder; from 2 to 30 dry parts of pigment fixation agents, parts are based on total dry content of the coating composition; a pH control agent in an amount adjusted to have a pH above 7; an aqueous liquid vehicle, and, then, ejecting an ink composition onto the coated fabric media to form a printed image.

In some examples, the coated fabric print medium includes a fabric substrate, and a coating layer on the fabric substrate that has a 0.5 gsm to 10 gsm dry coating weight basis.

The ink composition, that is ejected on the coated fabric print medium includes water, organic co-solvent, pigment having dispersant associated with or attached thereto, and polymer binder particles. The method can further include crosslinking imine-cross-linkable groups from the polymer binder particles in the ink composition as well as imine-cross-linkable groups from the fabric substrate with a subset of the imine-type groups of the crosslinking polymer.

As used herein, “ejecting” includes technologies where ink compositions or other fluids are ejected from jetting architecture, such as inkjet architecture. Inkjet architecture can include thermal or piezo inkjet pens. Additionally, such architecture can be configured to print varying drop sizes such as less than 10 nanograms (ng), less than 20 ng, less than 30 ng, less than 40 ng, less than 50 ng, etc. These upper limits can, in one example, also provide the upper limit of various ranges, where 1 ng or 2 ng can represent the lower end of the various range.

Ink compositions that can be printed on the coated fabric print media of the present disclosure can be pigmented ink with a binder polymer, such as latex binder particles, e.g., acrylic latex, or polyurethane particles. These solids can be carried by a liquid vehicle that includes water, organic cosolvent, and any of a number of other liquid ingredients, e.g., surfactant, biocide, sequestering agent, dispersing polymer, etc. The polymer binder particles can include, in some more specific examples, imine-cross-linkable groups that are available for reaction with the imine-type crosslinking groups of the crosslinking polymer (found in the coating or the coated fabric print medium, for example).

A wide variety of polyurethanes and/or latex polymers can be used for this purpose. The polyurethane may be aliphatic (straight-chained, branched, and/or alicyclic) or aromatic, or may be any of a variety of types of polyurethane, including polyester-type, some specific examples of commercially available aliphatic waterborne polyurethanes include Sancure® 1514, Sancure® 1591, Sancure® 2260, and Sancure® 2026 (all of which are available from Lubrizol Inc.). Some specific examples of commercially available castor oil-based polyurethanes include Alberdingkusa® CUR 69, Alberdingkusa® CUR 99, and Alberdingkusa® CUR 991 (all from Alberdingk Boley Inc.). Other examples can include polyester-type polyurethanes that may be carboxylated and/or sulfonated. An example aliphatic polyester-polyurethane binder that can be used is Impranil® DLN-SD (Mw 133,000 Mw; Acid Number 5.2; Tg −47° C.; Melting Point 175-200° C.) or Impranil® DL 1380 from Covestro (Germany), and an example of an aromatic polyester-polyurethane binder that can be used is Dispercoll® U42. Example components used to prepare the Impranil® DLN-SD or other similar anionic aliphatic polyester-polyurethane binders can include pentyl glycols, e.g., neopentyl glycol; C3 to C5 alkyl dicarboxylic acids, e.g., adipic acid; C4 to C8 alkyl diisocyanates, e.g., hexamethylene diisocyanate (HDI or HMDI); diamine sulfonic acids, e.g., 1-[(2-aminoethyl)amino]-methanesulfonic acid or 2-[(2-aminoethyl)amino]-ethanesulfonic acid; etc. Example components used to prepare the Dispercoll® U42 or other similar aromatic polyester-polyurethane binders can include aromatic dicarboxylic acids, e.g., phthalic acid; C4 to C8 alkyl dialcohols, e.g., hexane-1,6-diol; C4 to C8 alkyl diisocyanates, e.g., hexamethylene diisocyanate (HDI); diamine sulfonic acids, e.g., 2-[(2-aminoethyl)amino]-methanesulfonic acid or 1-[(2-aminoethyl)amino]-ethanesulfonic acid; etc. Other types of polyurethanes can also be used, such as polyether-type polyurethane, polycarbonate ester-polyether-type polyurethane, and/or polycarbonate-type polyurethane.

Other examples of the polyurethane polymeric compound that can be used include vinyl-urethane, acrylic urethane, polyurethane-acrylic, polyether polyurethane, polyester polyurethane, polycaprolactam polyurethane, or polyether polyurethane. Any of these examples may be aliphatic or aromatic. For example, the polyurethane may include aromatic polyether polyurethanes, aliphatic polyether polyurethanes, aromatic polyester polyurethanes, aliphatic polyester polyurethanes, aromatic polycaprolactam polyurethanes, or aliphatic polycaprolactam polyurethanes.

In another example, the polymer binder particles can be a latex polymer, such as a (meth)acrylic polymers, otherwise referred to as poly(meth)acrylate-based polymer or poly(meth)acrylates. Examples of poly(meth)acrylates include polymers made by hydrophobic addition monomers, such as C1-C12 alkyl acrylates, carboxylic containing monomers (e.g., acrylic acid, methacrylic acid), vinyl ester monomers (e.g., vinyl acetate, vinyl propionate, vinyl benzoate, vinyl pivalate, vinyl-2-ethylhexanoate, vinyl versatate, etc.), vinyl benzene monomer, C1-C12 alkyl acrylamide and methacrylamide (e.g., t-butyl acrylamide, sec-butyl acrylamide, N,N-dimethylacrylamide, etc.), crosslinking monomers (e.g., divinyl benzene, ethylene glycol dimethacrylate, bis(acryloylamido)methylene, etc.), and combinations thereof. As specific examples, polymers made from the polymerization and/or copolymerization of alkyl acrylate, alkyl methacrylate, and/or vinyl esters may be used. Any of the listed monomers (e.g., hydrophobic addition monomers, aromatic monomers, etc.) may be copolymerized with styrene or a styrene derivative. As specific examples, polymers made from the copolymerization of alkyl acrylate, alkyl methacrylate, and/or vinyl esters, with styrene or styrene derivatives may also be useful. The latex polymer, for example, can have an acid number from 0 mg KOH/g to 60 mg KOH/g, from 0 mg KOH/g to 50 mg KOH/g, from 5 mg KOH/g to 60 mg KOH/g, from 5 mg KOH/g to 50 mg KOH/g, or from 10 mg KOH/g to 40 mg KOH/g. The latex polymer can also have a glass transition temperature from −30° C. to 50° C., from −30° C. to 35° C., from −30° C. to 15° C., from 0° C. to 50° C., from 0° C. to 35° C., or from ° C. to 15° C., for example,

In another example, the polymer binder particles can include hybrid particles of the polyurethane and the latex polymer, for example. For example, a polyurethane core and a latex shell can be prepared as a polyurethane-latex hybrid by copolymerizing the latex monomers, e.g., for a (meth)acrylic latex polymer or styrene (meth)acrylic latex polymer, in the presence of polyurethane particles. Surfactant can be used in some examples, but in other examples, surfactant can be omitted because the polyurethane can have properties that allow it to act as an emulsifier for the emulsion polymerization reaction. An initiator can be added to start the polymerization of the latex monomers, resulting in the polyurethane-latex hybrid particles.

The pigment in the ink composition can include pigment colorant, for example. In some examples, the pigment can be present in an amount from 0.5 wt % to 12 wt %, from 0.5 wt % to 10 wt %, from 1 wt % to 8 wt %, or from 2 wt % to 6 wt % in the ink composition. The pigment in the ink composition can be self-dispersed with a polymer, oligomer, or small molecule; or can be dispersed with a separate dispersant. Furthermore, the pigment can be any of a number of pigments of any of a number of primary or secondary colors, or can be black or white, for example. More specifically, colors can include cyan, magenta, yellow, red, blue, violet, red, orange, green, etc. In one example, the ink composition can be a black ink with a carbon black pigment. In another example, the ink composition can be a cyan or green ink with a copper phthalocyanine pigment, e.g., Pigment Blue 15:0, Pigment Blue 15:1; Pigment Blue 15:3, Pigment Blue 15:4, Pigment Green 7, Pigment Green 36, etc. In another example, the ink composition can be a magenta ink with a quinacridone pigment or a co-crystal of quinacridone pigments. Example quinacridone pigments that can be utilized can include PR122, PR192, PR202, PR206, PR207, PR209, P048, P049, PV19, PV42, or the like. These pigments tend to be magenta, red, orange, violet, or other similar colors. In one example, the quinacridone pigment can be PR122, PR202, PV19, or a combination thereof. In another example, the ink composition can be a yellow ink with an azo pigment, e.g., PY74 and PY155. Other examples of pigments include the following, which are available from BASF Corp.: Paliogen® Orange, Heliogen® Blue L 6901F, Heliogen® Blue NBD 7010, Heliogen® Blue K 7090, Heliogen® Blue L 7101F, Heliogen® Blue L 6470, Heliogen® Green K 8683, Heliogen® Green L 9140, Chromophtal® Yellow 3G, Chromophtal® Yellow GR, Chromophtal® Yellow 8G, Igrazin® Yellow SGT, and Igralite® Rubine 4BL. The following pigments are available from Degussa Corp.: Color Black FWI, Color Black FW2, Color Black FW2V, Color Black 18, Color Black, FW200, Color Black 5150, Color Black S160, and Color Black 5170. The following black pigments are available from Cabot Corp.: Regal® 400R, Regal® 330R, Regal® 660R, Mogul® L, Black Pearls® L, Monarch® 1400, Monarch® 1300, Monarch® 1100, Monarch® 1000, Monarch® 900, Monarch® 880, Monarch® 800, and Monarch® 700. The following pigments are available from Orion Engineered Carbons GMBH: Printex® U, Printex® V, Printex® 140U, Printex® 140V, Printex® 35, Color Black FW 200, Color Black FW 2, Color Black FW 2V, Color Black FW 1, Color Black FW 18, Color Black S 160, Color Black S 170, Special Black 6, Special Black 5, Special Black 4A, and Special Black 4. The following pigment is available from DuPont: Ti-Pure® R-101. The following pigments are available from Heubach: Monastral® Magenta, Monastral® Scarlet, Monastral® Violet R, Monastral® Red B, and Monastral® Violet Maroon B. The following pigments are available from Clariant: Dalamar® Yellow YT-858-D, Permanent Yellow GR, Permanent Yellow G, Permanent Yellow DHG, Permanent Yellow NCG-71, Permanent Yellow GG, Hansa Yellow RA, Hansa Brilliant Yellow 5GX-02, Hansa Yellow-X, Novoperm® Yellow HR, Novoperm® Yellow FGL, Hansa Brilliant Yellow 10GX, Permanent Yellow G3R-01, Hostaperm® Yellow H4G, Hostaperm® Yellow H3G, Hostaperm® Orange GR, Hostaperm® Scarlet GO, and Permanent Rubine F6B. The following pigments are available from Sun Chemical: Quindo® Magenta, Indofast® Brilliant Scarlet, Quindo® Red R6700, Quindo® Red R6713, Indofast® Violet, L74-1357 Yellow, L75-1331 Yellow, L75-2577 Yellow, and LHD9303 Black. The following pigments are available from Birla Carbon: Raven® 7000, Raven® 5750, Raven® 5250, Raven® 5000 Ultra® II, Raven® 2000, Raven® 1500, Raven® 1250, Raven® 1200, Raven® 1190 Ultra®, Raven® 1170, Raven® 1255, Raven® 1080, and Raven® 1060. The following pigments are available from Mitsubishi Chemical Corp.: No. 25, No. 33, No. 40, No. 47, No. 52, No. 900, No. 2300, MCF-88, MA600, MA7, MA8, and MA100. The colorant may be a white pigment, such as titanium dioxide, or other inorganic pigments such as zinc oxide and iron oxide.

Specific other examples of a cyan color pigment may include C.I. Pigment Blue-1, -2, -3, -15, -15:1, -15:2, -15:3, -15:4, -16, -22, and -60; magenta color pigment may include C.I. Pigment Red-5, -7, -12, -48, -48:1, -57, -112, -122, -123, -146, -168, -177, -184, -202, and C.I. Pigment Violet-19; yellow pigment may include C.I. Pigment Yellow-1, -2, -3, -12, -13, -14, -16, -17, -73, -74, -75, -83, -93, -95, -97, -98, -114, -128, -129, -138, -151, -154, and -180. Black pigment may include carbon black pigment or organic black pigment such as aniline black, e.g., C.I. Pigment Black 1. While several examples have been given herein, it is to be understood that any other pigment can be used that is useful in color modification, or dye may even be used in addition to the pigment.

Furthermore, pigments and dispersants are described separately herein, but there are pigments that are commercially available which include both the pigment and a dispersant suitable for ink composition formulation. Specific examples of pigment dispersions that can be used, which include both pigment solids and dispersant are provided by example, as follows: HPC-K048 carbon black dispersion from DIC Corporation (Japan), HSKBPG-11-CF carbon black dispersion from Dom Pedro (USA), HPC-0070 cyan pigment dispersion from DIC, Cabojet® 250C cyan pigment dispersion from Cabot Corporation (USA), 17-SE-126 cyan pigment dispersion from Dom Pedro, HPF-M046 magenta pigment dispersion from DIC, Cabojet® 265M magenta pigment dispersion from Cabot, HPJ-Y001 yellow pigment dispersion from DIC, 16-SE-96 yellow pigment dispersion from Dom Pedro, or Emacol SF Yellow AE2060F yellow pigment dispersion from Sanyo (Japan).

Thus, the pigment(s) can be dispersed by a dispersant that is adsorbed or ionically attracted to a surface of the pigment or can be covalently attached to a surface of the pigment as a self-dispersed pigment. In one example, the dispersant can be an acrylic dispersant, such as a styrene (meth)acrylate dispersant, or other dispersant suitable for keeping the pigment suspended in the liquid vehicle. In one example, the styrene (meth)acrylate dispersant can be used, as it can promote π-stacking between the aromatic ring of the dispersant and various types of pigments. In one example, the styrene (meth)acrylate dispersant can have a weight average molecular weight from 4,000 Mw to 30,000 Mw. In another example, the styrene-acrylic dispersant can have a weight average molecular weight of 8,000 Mw to 28,000 Mw, from 12,000 Mw to 25,000 Mw, from 15,000 Mw to 25,000 Mw, from 15,000 Mw to 20,000 Mw, or about 17,000 Mw. Regarding the acid number, the styrene (meth)acrylate dispersant can have an acid number from 100 to 350, from 120 to 350, from 150 to 300, from 180 to 250, for example. Example commercially available styrene-acrylic dispersants can include Joncryl® 671, Joncryl® 71, Joncryl® 96, Joncryl® 680, Joncryl® 683, Joncryl® 678, Joncryl® 690, Joncryl® 296, Joncryl® 671, Joncryl® 696 or Joncryl® ECO 675 (all available from BASF Corp., Germany).

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise. In describing and claiming the examples disclosed herein, the singular forms “a”, “an”, and “the” include plural referents unless the context clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

The term “acid value” or “acid number” refers to the mass of potassium hydroxide (KOH) in milligrams that can be used to neutralize one gram of substance (mg KOH/g), such as the latex polymers disclosed herein. This value can be determined, in one example, by dissolving or dispersing a known quantity of a material in organic solvent and then titrating with a solution of potassium hydroxide (KOH) of known concentration for measurement.

The term “(meth)acrylate,” “(meth)acrylic,” or “(meth)acrylic acid,” or the like refers to monomers, copolymerized monomers, etc., that can either be acrylate or methacrylate (or a combination of both), or acrylic acid or methacrylic acid (or a combination of both). This can be the case for either dispersant polymer for a pigment dispersion or for dispersed polymer binder particles that may include co-polymerized acrylate and/or methacrylate monomers. Also, in some examples, the terms “(meth)acrylate” and “(meth)acrylic” can be used interchangeably, as acrylates and methacrylates described herein include salts of acrylic acid and methacrylic acid, respectively. Thus, mention of one compound over another can be a function of pH. Furthermore, even if the monomer used to form the polymer was in the form of a (meth)acrylic acid during preparation, pH modifications during preparation or subsequently when added to an ink composition can impact the nature of the moiety as well (acid form vs. salt form). Thus, a monomer or a moiety of a polymer described as (meth)acrylic acid or as (meth)acrylate should not be read so rigidly as to not consider relative pH levels, and other general organic chemistry concepts.

As used herein, “liquid vehicle” or “ink vehicle” refers to a liquid fluid in which colorant, such as pigments, can be dispersed and otherwise placed to form an ink composition. A wide variety of liquid vehicles may be used with the systems and methods of the present disclosure. Such liquid vehicles may include a mixture of a variety of different agents, including, water, organic co-solvents, surfactants, anti-kogation agents, buffers, biocides, sequestering agents, viscosity modifiers, surface-active agents, water, etc.

As used herein, “pigment” generally includes pigment colorants.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc. In some other examples, a range of 1 part to 20 parts should be interpreted to include not only the explicitly recited concentration limits of about 1 part to about 20 parts, but also to include individual concentrations such as 2 parts, 3 parts, 4 parts, etc. All parts are dry parts in unit weight, with the sum of all the coating components equal to 100 parts, unless otherwise indicated.

To further illustrate the present disclosure, an example is given herein. It is to be understood this example is provided for illustrative purposes and is not to be construed as limiting the scope of the present disclosure.

### Examples

A coating (pre-treatment) compositions formation is prepared in accordance with examples of the present disclosure, according to formulation listed in the Table 1. Such coating composition is prepared and tested to evaluate the durability and image properties on fabric substrates (printed with pigmented-inks with polyurethane binder). Chemical amounts are expressed on dry part units.

TABLE 1

| Chemical ID | Amount (dry parts) | Supplier | Chemical Function |
|---|---|---|---|
| PrintRite ® 376 | 35 | Lubrizol Inc | Polymeric binder |
| Calcium nitride | 10 | Aldrich Inc | Fixation agent |
| Carbodilite ® SV-02 | 10 | Nisshinbo-Chem Co | Crosslinker |
| Sodium hydroxide | Adjust to designed PH | Aldrich Inc | PH control agent |
| Dyewet ® 800 | 0.5 | BYK Inc | Surfactant |

The pre-treatment formation as prepared, in accordance with Table 1, is applied, at a dry coat weight of 2 gsm, to different textile print substrates: on 100% cotton fabric samples, on 50% cotton/50% polyester blend and on Nylon fabric samples using a textile padding machine equipped with two rubber rollers. The illustration samples are summarized in the Table 2. The pre-treatment compositions of Sample 2 and Sample 3 have a different pH, the Print sample of Exp. 1 has not been treated with the pre-treatment composition.

TABLE 2

| | Crosslink agent | Pre-treatment | |
|---|---|---|---|
| Sample ID | amount (dry parts) | pH | Textile substrates |
| Exp. 1 | No pre-treatment | NA | Cotton, cotton/pE blends, Nylon |
| (comparative) | | | |
| Exp. 2 | 10 | 8 | Cotton, cotton/pE blends, Nylon |
| Exp. 3 | 10 | 5 | Cotton, cotton/pE blends, Nylon |
| (comparative) | | | |

Cyan and black ink compositions are prepared for evaluating the image quality and durability when printed on fabric substrates coated with a coating composition in accordance with the present disclosure. Specifically, the ink compositions are formulated according to Table 3 below.

TABLE 3

| Ingredient | Category | Concentration (wt %) |
|---|---|---|
| Glycerol | Organic Co-solvent | 6 |
| LEG-1 | Organic Co-solvent | 1 |
| Crodafos ® N3 Acid (Croda Int.) | Surfactant/Emulsifier | 0.5 |
| Surfynol ® 440 (Evonik) | Surfactant | 0.3 |
| Acticide ® B20 (Thor Specialties) | Biocide | 0.22 |
| Impranil ® DLN-SD (Covestro) | Dispersed polymer binder | 6 |
| Pigment Black or Cyan | Dispersed Pigment | 3 |
| Deionized Water | Water | Balance |

Prints are generated by printing the ink compositions (black and cyan) on the coated fabrics as well as on samples of uncoated fabric using 3 dots per pixel (dpp) durability plots of ink composition using thermal inkjet pen A3410 pen, available from HP, Inc, (USA). After printing, the images on the coated fabric substrates are cured at 150° C. for 3 minutes.

The various print samples are then evaluated for the durability of printed image after washing, optical density (OD) and/or washfastness properties. Such data are obtained by measuring the optical density (OD) and L*a*b* values, which represented the “pre-washing” values, or reference black or color values. The printed fabric substrates are washed at 40° C. with laundry detergent (e.g., Tide® available from Procter and Gamble) for 5 cycles, air drying the printed fabric substrates between each washing cycle. After the five cycles, optical density (OD) and L*a*b* values are measured for comparison. The delta E (ΔE) values are calculated using the 1976 standard denoted as ΔECIE as well as the 2000 standard. For the Black and Cyan optical density, the higher the number is the better it is. For the L*a*b* change (ΔE) the smaller the number is the better it is. The data results are shown in Tables 4 and 5 below.

As can be seen in Tables 4 and 5, the fabric print sample (either cotton, cotton/polyester or Nylon) when treated with the pre-treatment composition according to the present disclosure, exhibits greater washfastness with respect to both OD and ΔE values.

TABLE 4

| | Cotton | | Cotton/pE | | Nylon | |
|---|---|---|---|---|---|---|
| | Black | Cyan | Black | Cyan | Black | Cyan |
| Sample ID | OD | OD | OD | OD | OD | OD |
| Comparative Exp 1 | 0.91 | 0.87 | 0.99 | 0.96 | 1.05 | 1.01 |
| Exp 2 | 1.23 | 1.22 | 1.04 | 1.07 | 1.11 | 1.04 |
| Comparative Exp 3 | 1.24 | 1.25 | 1.08 | 1.01 | 1.07 | 1.04 |

TABLE 5

| | Cotton | | Cotton/pE | | Nylon | |
|---|---|---|---|---|---|---|
| | ΔE | ΔE | ΔE | ΔE | ΔE | ΔE |
| Sample ID | black | cyan | black | cyan | black | cyan |
| Comparative Exp 1 | 6.0 | 4.8 | 9.3 | 8.4 | 9.5 | 11.5 |
| Exp 2 | 1.9 | 1.7 | 2.2 | 2.2 | 1.8 | 1.1 |
| Comparative Exp 3 | 6.9 | 7.2 | 12.4 | 11.6 | 5.8 | 5.0 |

1) A fabric coating composition, comprising:
a. from 2 to 50 dry parts of a crosslinking polymer,
b. from 5 to 60 dry parts of a polymeric binder;
c. from 2 to 30 dry parts of a pigment fixation agent, parts are based on the total dry content of the coating composition;
d. a pH control agent in an amount adjusted to have a pH above 7;
e. and an aqueous liquid vehicle.

2) The fabric coating of claim 1, wherein the crosslinking polymer is a polyimine, a polycarbodiimide, a mixture of polyimines and polycarbodiimides, or a polymer that is both a polyimine and a polycarbodiimide.

3) The fabric coating of claim 1, wherein the crosslinking polymer includes a polyimine including multiple imine groups, wherein the polyimine has a weight average molecular weight of ranging from 1,000 Mw to 150,000 Mw.

4) The fabric coating of claim 1, wherein the crosslinking polymer is a polycarbodiimide crosslinking polymer with multiple carbodiimide groups and having a weight average molecular weight of ranging from 1,000 Mw to 150,000 Mw.

5) The fabric coating of claim 1, wherein the crosslinking polymer is present in an amount ranging from about 2 to about 50 dry parts of the total dry content of the coating composition.

6) The fabric coating of claim 1, wherein the pigment fixation agent is a multivalent metal salt.

7) The fabric coating of claim 1, wherein the pigment fixation agent is present in an amount representing from about 5 to 20 dry parts of the total dry content of the fabric coating composition.

8) The fabric coating of claim 1, wherein the amount of pH control agent is adjusted to have a pH greater than 8.

9) The fabric coating of claim 1, wherein the polymeric binder is selected from the group consisting of polyurethane and polyurethane derivative such as vinyl-urethane, acrylic urethane, polyurethane-acrylic, polyether polyurethane, polyester polyurethane, polycaprolactam polyurethane, polyether polyurethane, and a combination.

10) The fabric coating of claim 1, wherein the polymeric binder is a polyurethane polymer.

11) The fabric coating of claim 1, wherein the average molecular weight of the polymeric binder is in the range of from about 20,000 Mw to about 200,000 Mw

12) A coated fabric print medium, comprising:
a. a fabric base substrate; and
b. a coating layer applied on, at least, one side of the fabric base substrate, the coating layer including from 2 to 50 dry parts of a crosslinking polymer, from 5 to 60 dry parts of a polymeric binder; from 2 to 30 dry parts of pigment fixation agents, parts are based on total dry content of the coating composition; a pH control agent in an amount adjusted to have a pH above 7; and an aqueous liquid vehicle.

13) The coated fabric print medium of claim 12, wherein the coating layer is applied on the fabric substrate, at a coat weight ranging from about 0.5 gsm to about 10 gsm.

14) A method of textile printing comprising
a. providing a coated fabric print medium having a fabric substrate and a coating layer on the fabric substrate having a 0.5 gsm to 10 gsm dry coating weight basis, the coating layer including from 2 to 50 dry parts of a crosslinking polymer, from 5 to 60 dry parts of a polymeric binder; from 2 to 30 dry parts of pigment fixation agents, parts are based on total dry content of the coating composition; a pH control agent in an amount adjusted to have a pH above 7; and an aqueous liquid vehicle;
b. and ejecting an ink composition onto the surface of said coated fabric print medium to form a printed image.

15) The method of textile printing according to claim 14 wherein the ink composition is a pigmented ink with a binder polymer.
